(19) United States
(12) Patent Application Publication
(10) Pub. No.: US 2014/0068595 A1
(43) Pub. Date: Mar. 6, 2014

(54) AUTOMATIC MOBILE APPLICATION UPDATES

(71) Applicants: Ofer Belinsky, Holon (IL); Yaniv Shachar, (US); Alon Mei-Raz, (US)

(72) Inventors: Ofer Belinsky, Holon (IL); Yaniv Shachar, (US); Alon Mei-Raz, (US)

(21) Appl. No.: 13/597,139

(22) Filed: Aug. 28, 2012

(51) Int. Cl. G06F 9/44

(52) U.S. Cl. 717/173

(57) ABSTRACT

Automatic application updates can be achieved by an application she executing on a mobile device. Upon startup when executed by a processing resource of the mobile device, the application shell attempts a connection to a developer service using a communication feature of the mobile device. Following a successful attempt, the application shell obtains non-native functional code for the application shell from the developer service via the connection. Following an unsuccessful attempt, the application shell obtains non-native functional code cached by the mobile device. However obtained, the application shell hosts the functional code such that, via the application shell, the functional code accesses a mobile device feature and provides a primary application function.

### BACKGROUND

Mobile devices such as smartphones and tablets have become highly popular computing platforms providing considerable computing capabilities. Typically, mobile device users obtain applications from a vendor controlled web service commonly referred to as an application store. Prior to availability through such a web service, the vendor requires the application to go through a review process. Once installed, every update to the application, even the smallest bug fix, is first submitted to the vendor for approval before it can be manually installed by the user. In a particular example, a smart phone user may receive daily notifications that updates are available for previously installed applications. The user then accesses the application store and manually selects an update option causing the updates to be delivered. Depending on the number of applications installed, this can be a daily if not more frequent process for the user.

### DRAWINGS

FIG. 1 depicts an environment in which various examples may be implemented,

FIGS. 2, 3, 4, and 5 depict example systems that may operate in the environment of FIG. 1.

FIG. 6 is a flow diagram depicting steps taken to implement an example.

FIG. 7 is a sequence diagram illustrating steps taken to implement an example.

### DETAILED DESCRIPTION

### Introduction

Mobile application developers rely on application vendors to distribute their applications. The vendor provides what is commonly referred to as an application or “app” store. The app store provides a web interface through which users can access and download applications onto their mobile devices. A common practice for updating mobile applications is for a developer to submit updated code to the application vendor for approval. Once approved, the update is made available to users via the vendor's app store. Vendor approval takes time delaying the ultimate deployment of the update. This process also relies on the user to actively install the updates after those updates are made available by the vendor. Such reliance often leads to fragmentation where different users run different versions of the application.

An alternative approach has been to provide some of the application content via the web, usually inside a user interface control or component that displays some part of a website, suited to mobile devices. This approach allows for timely updates of the application but is usually restricted in capabilities, since the web site itself does not have access to the mobile device capabilities such as camera and positioning features.

Various embodiments described below were developed to reduce the manual effort placed on users to update applications installed on their mobile devices while helping to ensure that the application has access to important features of the mobile device on which it is running. Examples discussed below also provide a more direct approach for application developers to deliver application updates to mobile users,

In accordance with the examples discussed below, a mobile application is divided into two parts—a native application shell and non-native functional code. The shell is native in that it is dependent upon the platform of the particular mobile device on which it is to be installed. The functional code is non-native in that it is not dependent upon any given platform. Instead it is designed to be hosted by a native application shell for the given application. Thus, the same non-native functional code can be hosted by different application shells designed for different mobile device platforms.

Discussed in more detail later, the non-native functional code is responsible for delivering a primary application function. The native application shell is responsible for hosting the functional code and supplying a secondary application function in support of the primary function. A secondary function is one that allows the application to utilize a feature of the mobile device on which it is executing. Such mobile device features include camera and positioning features. A primary function is a function for which the application is provided. Imagine, for example, a mobile application for making hotel reservations. A primary function is making a reservation at a user selected hotel. A secondary function, in this example, may be the acquisition of location data via a device's positioning feature or use in identifying a list of nearby hotels.

The native application shell can be provided via a vendor controlled application store while the non-native functional code can he provided by a separate and independent developer managed service. In other words, the application shell, once obtained from the vendor and installed can be executed by a mobile device user. Upon start-up, the application shell retrieves the functional code from the service managed by the developer. In this fashion, the developer can periodically update the functional code at the developer controlled service independently of the application store. These updates in turn serve to automatically update the application installed on any number of mobile devices. Without taking manual steps to access an application store and retrieve those updates, the user of a mobile device can be assured access to latest version of the application each time that application is launched.

The following description is broken into sections. The first, labeled “Environment,” describes an environment in which various embodiments may be implemented. The second section, labeled “Components,” describes examples of various physical and logical components for implementing various embodiments. The third section, labeled as “Operation,” describes steps taken to implement various embodiments.

### Environment

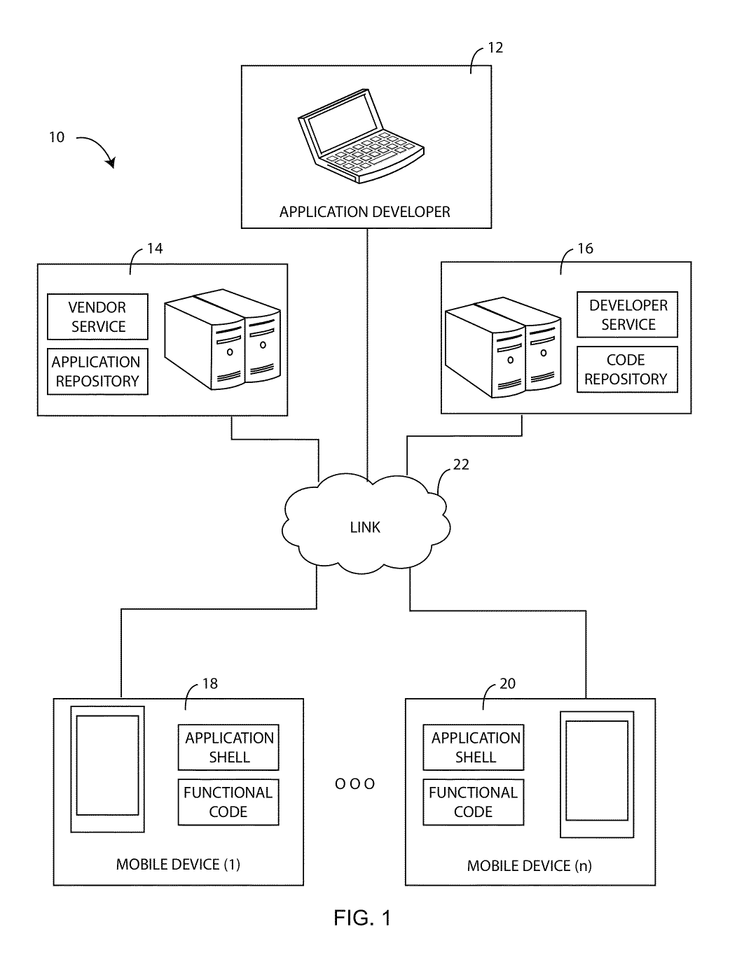

FIG. 1 depicts an environment 10 in which various embodiments, discussed below, may be implemented. Environment 10 includes application developer device 12, vendor service 14, developer service 16, and mobile devices 18 and 20. Application developer device 12 represents a computing device from which an application developer can submit an application as well as updates to that application. As discussed above, such an application includes a native application shell and non-native functional code. The developer supplies the shell to vendor service 14 and the functional code to developer service 16. Updates to the functional code can be periodically communicated to developer service 16.

Vendor service 14 represents the hardware and programming configured to distribute applications to mobile devices 18, 20 including a native application shell received from developer 12. Vendor service 14 may function as an application store. The application shell will appear in the store like any other application available for download. Developer service 16 represents the hardware and programming configured to supply non-native functional code to mobile devices 18, 20. Developer service 16 does so following the start-up and at the request of an application shell executing on a given mobile device 18, 20.

Mobile devices 18 and 20 represent mobile computing devices such as tablets or smart phones configured to download and install applications from vendor service 14. Where an installed application is a native application shell, the application shell, on start-up, causes the given mobile device 18, 20 to obtain non-native functional code for the application shell from developer service 16. Once obtained, the application shell hosts the functional code. The hosted functional code can then access, via the application shell, a mobile device feature and provide a primary application function. Again, such a feature can include a camera or a positioning feature.

Updates can be periodically made to the non-native functional code maintained by developer service 16, such that, upon each start-up on mobile devices 18, 20, the user has access to the latest application version without needing to communicate with vendor service 14. Furthermore, application updates can be quickly deployed to mobile devices 18, 20 via developer service 16 without requiring a review by vendor service 14.

Components 12-20 are shown being connected via link 22. Link 22 represents generally one or more of a cable, wireless, fiber optic, or remote connections via a telecommunication link, an infrared link, a radio frequency link, or any other connectors or systems that provide electronic communication. Link 22 may include, at least in part, an intranet, the Internet, or a combination of both. Link 22 may also include intermediate proxies, routers, switches, load balancers, and the like.

### Components

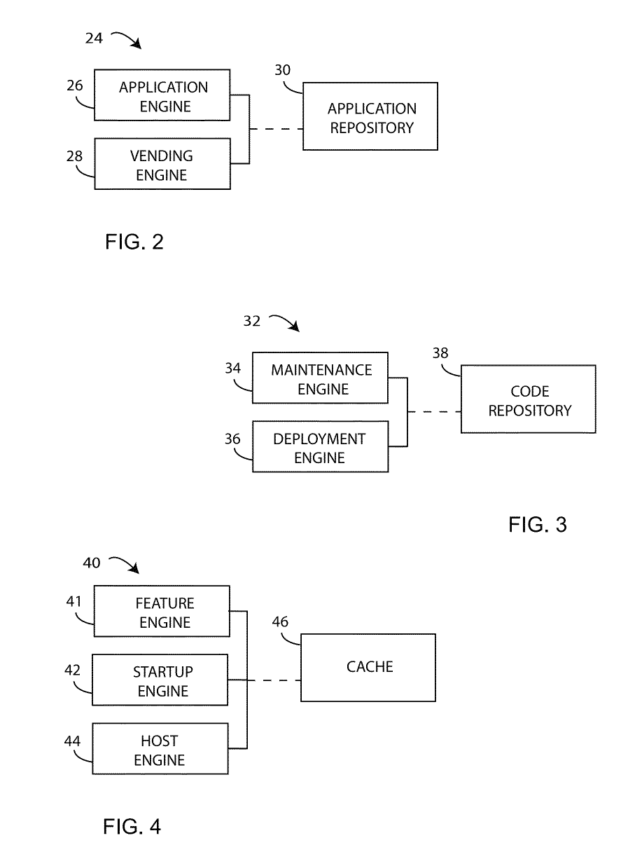

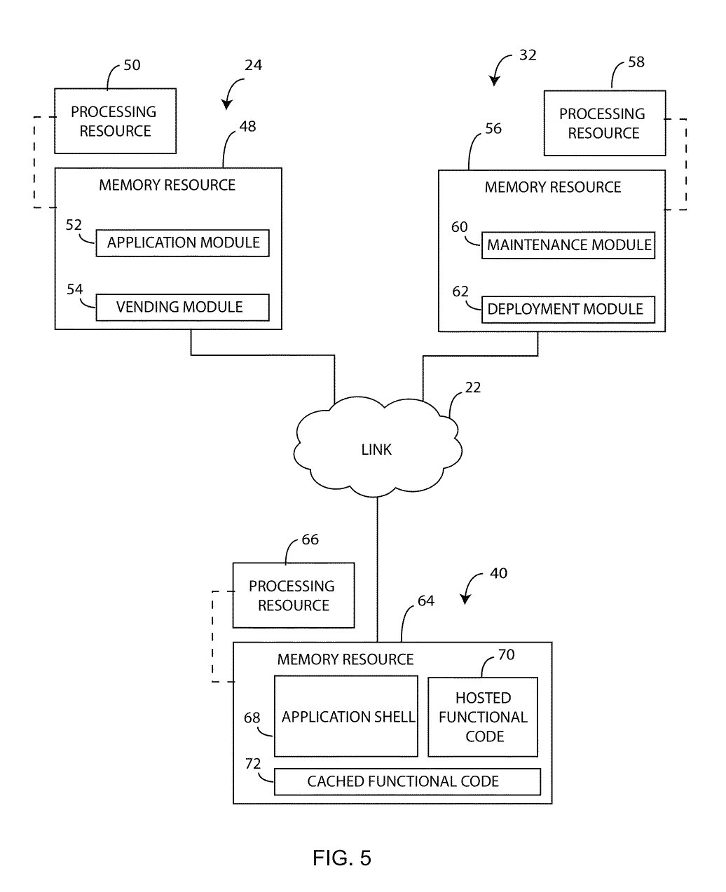

FIGS. 2, 3, and 4 depict examples of physical and logical components for implementing various embodiments. In FIGS. 2-4, various components are identified as engines. In describing the engines of FIGS. 2-4, focus will be on each engine's designated function. However, the term engine, as used herein, refers to a combination of hardware and programming configured to perform a designated function. As is illustrated later with respect to FIG. 5, the hardware of each engine, for example, may include a processor and a memory, while the programing is code stored on that memory and executable by the processor to perform the designated function.

FIG. 2 depicts application service 24 responsible for distributing applications to mobile devices. Application service 24 is shown to include application engine 26 and vending engine 28. Application engine 26 is configured to receive applications and application updates from developers. As an example, application engine 26 may provide an interface allowing the developers to upload the applications and periodic updates. The uploaded applications may be installation packs designed to be downloaded and installed on a mobile device. Once reviewed and approved, application engine 26 stores the installation packs in application repository 30 which represents data storage available to system 24.

Vending engine 28 is configured to provide a requested application or corresponding update to a mobile device. In an example, vending engine 28 is responsible for providing an application store from which users of mobile devices can select and download applications and application updates. In the example of FIG. 2, those applications are applications stored in application repository 30. Thus, where application repository 30 stores a native application shell for a given application, vending engine 28 supplies that shell in a response to a request for that application from a mobile device Thus, the mobile device user may be unaware that a shell, as opposed to a “complete” application, is being downloaded and installed. As alluded to above, upon start-up of the newly installed native application shell acquires and hosts the functional code to fully assemble the “complete” application. The term complete is used simply to describe an application that is able to perform a primary application function.

FIG. 3 depicts developer service 32 responsible for deploying non-native functional code to mobile devices. Developer service 32 is shown to include maintenance engine 34 and deployment engine 36. Maintenance engine 34 is responsible for maintaining the latest version of the non-native functional code for a given application or applications. Maintenance engine 34 may periodically receive updates for the non-native functional code from an application developer device and store the update as the current version in code repository 38.

Deployment engine 38 is responsible for deploying non-native functional code at the request of that code's corresponding application shell executing on a mobile device. Upon start-up, the application shell requests its corresponding functional code from developer service 32. Deployment engine 36 receives the request, retrieves the latest version of the non-native functional code from code repository 38, and returns that functional code to be hosted by the requesting application shell.

FIG. 4 depicts application system 40 responsible for acquiring functional code for a native application shell executing on a mobile device. Application system 40, for example, may be implemented by a mobile device with a native application shell installed. In other words, the installed native application shell can provide the programming used by the mobile device to implement application system 40. Application system 40 is shown to include feature engine 41, startup engine 42, and host engine 44. Feature engine 41 is configured to exercise a feature of the mobile device on behalf of functional code being hosted by host engine 44. Such mobile device features can include, but are not limited to, camera and location features. Camera features can include using the mobile device's camera to capture new images. Location features can include utilizing a mobile device's location functionality to identifying a current position of the mobile device.

Startup engine 42 is configured to, upon startup of an application shell, attempt a connection to a developer service using a communication feature of the mobile device. Following a successful attempt, startup engine 42 is responsible for obtaining non-native functional code for the application shell from the developer service via the connection. Following an unsuccessful attempt to connect to the developer service, startup engine 42 is responsible for obtaining non-native functional code cached by the given mobile device. The cached functional code, for example, may be stored in cache 46. Cache 46 represents nonvolatile memory supplied by the mobile device executing the application shell.

Host engine 44 is configured to host the functional code, however obtained by startup engine 42, such that, via the application shell, the functional code accesses a mobile device feature and provides a primary application function. As noted above, the mobile device feature may be a camera feature or a location feature accessed through feature engine 41. If startup engine 42 makes a successful connection with the developer service to obtain the functional code, one can be assured that the complete application that results from the hosting of the functional code is the latest version made available by the application's developer. If a connection to developer service is not available upon startup of the application shell, a cached version of the functional code can be obtained and hosted avoiding downtime.

As noted above, system 40 can be implemented as a mobile device with a native application shell installed. Upon startup when executed by the processor of the mobile device, the application shell performs the functions of feature engine 41, startup engine 42, and host engine 44. Upon startup, if startup engine 42 makes a successful connection and obtains functional code from the developer service, startup engine 42 then updates cache 46 to include the obtained functional code. Upon a subsequent startup, if the connection attempt fails, startup engine 42 obtains that cached functional code from cache 46. Host engine 44 then hosts that cached functional code such that, via the application shell, the cached functional code can access a mobile device feature and provide the updated primary application function.

Moving to FIG. 5, vendor service 24, developer service 34, and application system 40 interconnected via link 32. In FIG. 5, each component 24, 32, and 66 is shown as including a memory resource 48, 56, or 64 and a corresponding processing resource 50, 58, or 66. Each memory resource 48, 56, and 64 represents generally any number of memory components capable of storing instructions that can be executed by a corresponding processing resource. Each memory resource 48, 56, and 64 may be integrated in a single device or distributed across devices. Likewise each processing resource 50, 58, and 66 represents any number of processors capable of executing instructions stored by a corresponding memory resource. Each processing resource 50, 58, or 66 may be integrated in a single device or distributed across devices. Further, each memory resource 48, 56, or 64 may be fully or partially integrated in the same device as its corresponding processing resource or each may be separate but accessible to that device and processing resource.

In foregoing discussion directed to FIGS. 2-4, various engines were described as combinations of hardware and programming. Such engines may be implemented in a number of fashions. Looking at FIG. 5, the programming may be processor executable instructions stored on tangible memory resources, such as one or more of memory resources 58, 56, and 64. The hardware may include a processing resource for executing those instructions such as one or more of processing resources 50, 58, and 66.

Thus, in one example, memory resource 64 can be said to store program instructions that when executed by processor resource 66 implement application system 40 of FIG. 4. Furthermore, the program instructions can be part of an installation package that when installed can be executed by processing resource 66 to implement application system 40. In this case, the memory resource storing the installation package may be a portable medium such as a CD, DVD, or flash drive or a memory maintained by a server from which the installation package can be downloaded and installed. Such a server may be a component of application service 24. In another example, the program instructions may be part of an application or applications already installed. Here, memory resource 64 may be the integrated memory of a mobile device storing a native application shell 68 obtained from vendor service 24. Processing resource 66 of the mobile device and application shell 68, together, operate to implement application system 40.

Continuing with FIG. 5, memory resource 48 of vendor service 24 is shown to include application module 52 and vending module 54. Application module 52 represents program instructions that, when executed, cause processing resource 50 to implement application engine 26 of FIG. 2. Likewise, vending module 54 represents program instructions that when executed cause the implementation of vending engine 28. Memory resource 56 of developer service 32 is shown to include maintenance module 60 and deployment module 62. Maintenance module 60 represents program instructions that, when executed, cause processing resource 58 to implement maintenance engine 34 of FIG. 3. Likewise, deployment module 62 represents program instructions that when executed cause the implementation of deployment engine 36.

Memory resource 40 of application system 40 is shown to include application shell 68, hosted functional code 70, and cached functional code 72. Application shell 68 represents native program instructions that, when executed, cause processing resource 58 to implement feature, startup, and host engines 41, 42, and 44 of FIG. 4. Hosted functional code represents non-native functional code obtained from developer service 32 and hosted by application shell 68. Cached functional code 72 represents non-native functional code cached for use when a connection to developer service cannot be made to obtain functional code upon startup of application shell 68.

### Operation

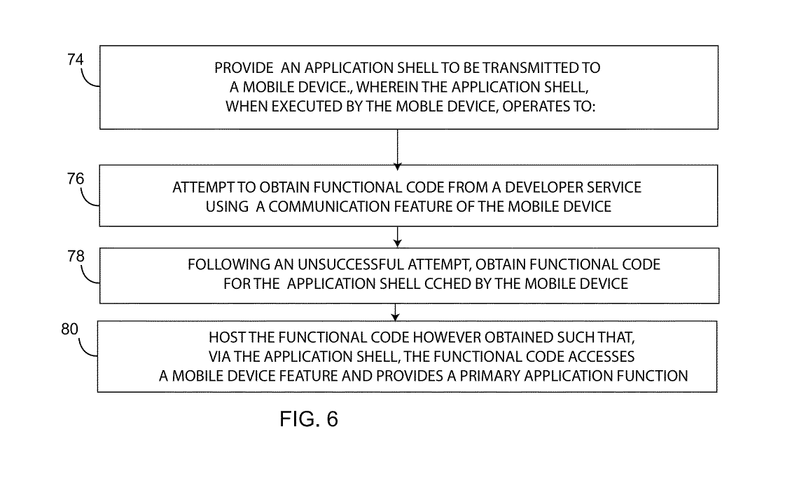

FIG. 6 is a flow diagram of steps taken to implement a method for enabling automatic updates of an application installed on a mobile device. In discussing FIG. 6, reference may be made to the diagrams of FIGS. 1-5 to provide contextual examples. Implementation, however, is not limited to those examples.

The method starts with the provision, from a vendor service, of an application shell to be transmitted to and installed on a mobile device (step 74). Referring to FIGS. 2 and 5, step 74 may be implemented by vendor service 24. Alternatively, step 74 may be accomplished by an application developer by creating the application shell The application shell, when executed by the mobile device, is configured to perform the remaining steps of FIG. 6.

Upon startup of the application shell an attempt is made to obtain functional code from a developer service using a communication feature of a mobile device (step 76). Referring back to FIG. 4, startup engine 42 may be responsible for step 76. Following an unsuccessful attempt, functional code cached by the mobile device is obtained (step 78). Again referring to FIG. 4, startup engine 42 may implement step 78 by obtaining functional code from cache 46. The functional code, however obtained, is hosted such that, via the application shell, the functional code accesses a mobile device feature and provides a primary application function (step 80). Host engine 44 of FIG. 4 may be responsible for implementing step 80 with the aid of feature engine 41. It is noted that, with respect to the mobile device, the application shell may be a native application shell and the functional code may be non-native functional code.

If successful in obtaining the functional code from the developer service, the application shell will, when executed, cause the mobile device to update its stored cached functional code with that obtained functional code. Upon a subsequent startup when executed, the application shell provided in step 74 will attempt to obtain updated functional code from the developer service using the communication feature. If successful here, the executing application shell will host the updated functional code such that, via the application shell, the updated functional code accesses a mobile device feature and provides an updated primary application function. If a later attempt on a subsequent startup is not successful, the executing application she will obtain the previously updated cached functional code stored by the mobile device.

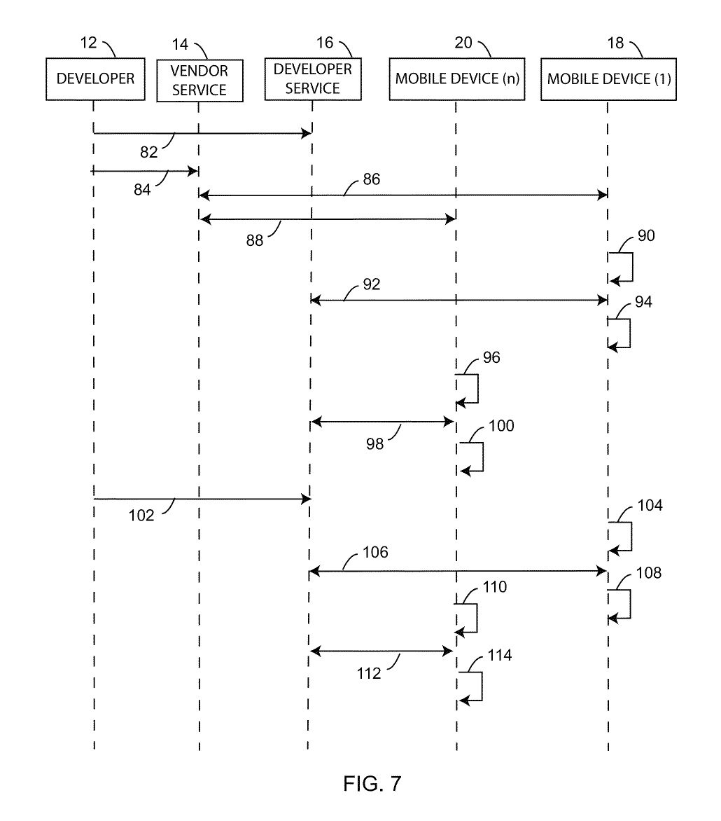

To summarize and provide a contextual overview, FIG. 7 is a sequence diagram illustrating steps taken by the components of environment 10 in FIG. 1 to automatically update mobile applications. The following presumes that a developer has created an application to be assembled from a native application shell and non-native functional code. Initially, through developer device 12, the non-native functional code is sent to developer service 16 (step 82) and the application shell is provided to vending service 14 (step 84).

Vendor service 14, advertises the application through its application store. Mobile device (1) 18 can then access and interact with the application store to identify and request the application. In response to that request, vendor service 14 returns the native application shell for the application to mobile device (1) where it is installed (step 86). Mobile device (n) 20 also interacts with vendor service 14 to obtain and install the native application shell (step 88).

A user causes mobile device (1) 18 to execute its installed native application shell (step 90). Upon startup, the application shell uses a communication feature of mobile device (1) 18 and attempts to connect with developer service 16, and, upon success, obtains the non-native functional code for the application (step 92). The application shell executing on mobile device (1) 18 then hosts the obtained non-native functional code such that, via the application shell, the functional code accesses a feature of mobile device (1) 18 and provides a primary application function for the user (step 94). The executing application shell also causes mobile device (1) 18 to cache the obtained non-native functional code for later use should a connection to developer service 16 not be available.

Similarly, another user causes mobile device (n) 20 to execute its installed native application shell (step 96). Upon startup, the application shell uses a communication feature of mobile device (n) 20 and attempts to connect with developer service 16, and, upon success, obtains the non-native functional code for the application (step 98). The application shell executing on mobile device (n) 20 then hosts the obtained non-native functional code such that, via the application shell, the functional code accesses a feature of mobile device (n) 18 and provides a primary application function for the user (step 100). The executing application shell also causes mobile device (n) 20 to cache the obtained non-native functional code for later use should a connection to developer service 16 not be available.

At any time, the developer may supply updated non-native functional code for the application to developer service 16 (step 102). Upon a subsequent startup of the application shell on mobile device (1) 18, the application shell uses the communication feature of mobile device (1) 18 to establish a connection with and obtain the updated functional code from developer service 16 (step 106). The application shell executing on mobile device (1) 18 hosts the obtained updated functional code such that, via the application shell, the updated functional code accesses a feature of mobile device (n) 18 and provides an updated primary application function for the user (step 108).

Upon a subsequent startup of the application shell on mobile device (n) 20, the application shell uses the communication feature of mobile device (n) 20 to attempt a connection with developer service 16 (step 112). Assuming that attempt is not successful, the application shell obtains the functional code previously cached by mobile device and hosts the cached functional code such that, via the application shell, the cached functional code accesses a feature of mobile device (n) 18 and provides a primary application function for the user (step 114).

Thus, when connections to developer service 16 are available, mobile devices 18 and 20 can be assured access to the latest version of the application each time that application is executed. The application developer need only supply updated non-native functional code to vendor service 16. If a connection fails, a given mobile device 18 or 20 can then utilize previously cached functional code to avoid downtime. So, when launching the application on mobile devices 18 and 20, the users of mobile device 18 and 20 may very well not be aware they are executing application shells that rely on obtaining functional code to provide the desired primary application function desired by the users.

### Conclusion

FIGS. 1-5 aid in depicting the architecture, functionality, and operation of various embodiments. In particular, FIGS. 2-5 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each such component or various combinations thereof may represent a circuit or a number of interconnected circuits to implement the specified logical function(s).

Embodiments can be realized in any non-transitory computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any non-transitory media that can contain, store, or maintain programs and data for use by or in connection with the instruction execution system. Computer readable media can comprise any one of many physical media such as, for example, electronic, magnetic, optical, electromagnetic, or semiconductor media More specific examples of suitable computer-readable media include, but are not limited to, hard drives, solid state drives, random access memory (RAM), read-only memory (ROM), erasable programmable read-only memory, flash drives, solid state devices (SSDs), and portable compact discs.

Although the flow diagrams of FIG. 6-7 show specific orders of execution, the orders of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A system for automatically updating an application installed on a mobile device, the system comprising a computer readable medium storing a native application shell provided or to be provided by a vendor service, the application shell, upon startup when executed by a processing resource of the mobile device, is configured to:
attempt a connection to a developer service using a communication feature of the mobile device;
following a successful attempt, obtain non-native functional code for the application shell from the developer service via the connection;
following an unsuccessful attempt, obtain non-native functional code cached by the mobile device; and
host the functional code, however obtained, such that, via the application shell, the functional code accesses a mobile device feature and provides a primary application function.

2. The system of claim 1, wherein the startup is a first startup, the connection is a first connection and the application shell, upon a second startup when subsequently executed by the processing resource of the mobile device, is configured to:
attempt a second, subsequent connection to the developer service using the communication feature of the mobile device; and
upon a successful second connection attempt, obtain updated functional code for the application shell from the developer service, and host the updated functional code such that, via the application shell, the updated functional code accesses a mobile device feature and provides an updated primary application function.

3. The system of claim 1, wherein the application shell, upon startup when executed by a processing resource of the mobile device, is configured to:
upon a successful attempt, obtain functional code for the application shell from the developer service and cause the mobile device to update its stored cached functional code with that obtained functional code.

4. The system of claim 3, wherein the startup is a first startup, the connection is a first connection and the application shell, upon a second startup when subsequently executed by the processing resource of the mobile device, is configured to:
attempt a second, subsequent connection to the developer service using he communication feature of the mobile device; and
upon an unsuccessful second connection attempt, obtain the updated cached functional code stored by the mobile device, and host the updated cached functional code such that, via the application shell, the updated cached functional code accesses a mobile device feature and provides the primary application function.

5. The system of claim 1, wherein:
the computer readable medium is a memory resource of the vendor service storing the native application shell to be obtained by the mobile device; and
the vendor service is independent of the developer service.

6. The system of claim 1, wherein:
the computer readable medium is a memory resource of the mobile device storing the native application shell obtained by the mobile device from the vendor service; and
the vendor service is independent of the developer service.

7. The system of claim 6, further comprising the processing resource.

8. A developer service comprising:
a maintenance engine configured to maintain a first version of non-native functional code during a first time period and a second, updated version of the non-native functional code during a second, subsequent time period, the non-native functional code configured, when hosted by an associated native application shell executing on a mobile device, to access a feature of the mobile device and provide a primary application function; and
a deployment engine configured to:
during the first time period, receive first requests for functional code from a plurality of mobile devices, each first request being sent upon startup of a copy of the associated application shell on one of the plurality of mobile devices, and returning, to each of the plurality of mobile devices the first version of the functional code to be hosted by the application shell executing on that mobile device; and
during the second time period, receive second requests for functional code from the plurality of mobile devices, each second request being sent upon a subsequent startup of a copy of the associated application shell on one of the plurality of mobile devices, and returning, to each of the plurality of mobile devices the second version of the functional code to be hosted by the associated application shell executing on that mobile device.

9. The developer service of claim 8, wherein each copy of the application shell is supplied to a given mobile device from a vendor service independent of the developer service.

10. The developer service of claim 8, wherein the mobile device feature includes at least one of a camera feature and a location feature.

11. A method for enabling automatic updates of an application installed on a mobile device, comprising providing an application to be transmitted to the mobile device, wherein the application shell, when executed by a processing resource of the mobile device, is configured to:
upon startup, attempt to obtain functional code from a developer service using a communication feature of the mobile device;
following an unsuccessful attempt, obtain functional code cached by the mobile device; and
host the functional code however obtained such that, via the application shell, the functional code accesses a mobile device feature and provides a primary application function.

12. The method of claim 11, wherein the provided application shell, when executed by a processing resource of the mobile device, is configured to:
upon a subsequent startup, attempt to obtain updated functional code from the developer service using the communication feature; and
following a successful attempt to obtain updated functional code, host the updated functional code such that, via the application shell, the updated functional code accesses a mobile device feature and provides an updated primary application function.

13. The system of claim 11, wherein the provided application shell, when executed by a processing resource of the mobile device, is configured to:
upon a successful attempt, cause the mobile device to update its stored cached functional code with that obtained functional code.

14. The system of claim 13, wherein the provided application shell, when executed by a processing resource of the mobile device, is configured to:
upon a subsequent startup, attempt to obtain updated functional code from the developer service using the communication feature; and
following an unsuccessful attempt to obtain updated functional code, obtain the updated cached functional code stored by the mobile device, and host the updated cached functional code such that, via the application shell, the updated cached functional code accesses a mobile device feature and provides the primary application function.

15. The method of claim 11, wherein, with respect to the mobile device, the application shell is a native application shell and the functional code is non-native functional code.
